(19) United States
(12) Patent Application Publication
(10) Pub. No.: US 2007/0189926 A1
(43) Pub. Date: Aug. 16, 2007

(54) Device for supplying blood tubes to a whole blood analyser

(75) Inventor: Roger Le Comte, Perols (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: HORIBA ABX SAS, Montpellier (FR)

(21) Appl. No.: 10/590,075

(22) PCT Filed: Mar. 11, 2005
(86) PCT No.: PCT/FR05/00594

§ 371 Date: Aug. 21, 2006

(30) Foreign Application Priority Data
Mar. 16, 2004 (FR) 0402688

(51) Int. Cl. G01N 35/00

(52) U.S. Cl. 422/65

(57) ABSTRACT

A device for supplying whole blood analyzers with tubes of blood. A stirring device is arranged upstream with respect to at least one analyzer. A first transport device conveys blood tubes one after another in front of the stirring device, and a second transport device conveys the blood tubes stirred by the stirring device one after another to a sampling point of the analyzer. A mechanism picks up separately the blood tubes which are not yet stirred, places the tubes in front of the stirring device to be stirred thereby, and to be separately removed from the stirring device and placed on a transport for conveying the stirred tubes to the sampling point of the analyzer, thereby making it possible to use at least one analyzed devoid of stirring.

The invention relates to a device for supplying tubes of blood to a whole blood analyser.

Whole blood analysers are analysers which carry out analyses on tubes of blood containing all the elements of the blood, in contrast to analysers which work on blood plasma or serum.

In contrast to the analyses carried out on blood plasma or serum the blood which is to be analysed by a whole blood analyser has to be carefully mixed a very short time before the analysis. This agitation phase is absolutely necessary in order to homogenise the blood so as to re-suspend the cells which naturally settle out when the tube is motionless, and it has to be carried out in accordance with the recommendations of the standardisation committees.

This agitation phase is treated differently depending on the type of analyser used and its degree of automation. In the simplest analysers there are no agitation means in the apparatus and the agitation then has to be carried out manually by the operator prior to the analysis.

In more sophisticated analysers, and particularly in haematology equipment, the tubes are installed before analysis in agitators made up of wheels or cassettes.

In agitators provided with wheels the tubes of blood are placed in notches arranged around the periphery of a wheel, as disclosed by U.S. Pat. No. 4,475,411. Each tube is then inverted and returned to its initial position on each revolution of the wheel. The quality of the agitation is good but the automation is limited to the capacity of the wheel, which has to be changed each time it is used. It is difficult to imagine connecting an analyser of this kind to an automatic line.

In cassette-type agitators the tubes are placed in cassettes before being loaded into an analyser. The analyser then arranges for the agitation of the tubes followed by the analysis and storage of the analysed cassettes. A cassette-type agitator is described in U.S. Pat. No. 5,232,081.

The cassette-type transporting and storage devices show their limitations in numerous cases, particularly when it comes to passing a sample through an analyser for a second time or asking for a specific analysis. In fact, this requires the handling of a complete cassette for each individual case.

The agitation means used differ depending on the particular manufacturers. In the field of haematology, agitation is essentially carried out by oscillation, vortex and inversion.

An example of agitation by oscillation is described in U.S. Pat. No. 4,609,017. The cassettes containing the tubes are loaded horizontally onto a moving belt which is oscillated so as to agitate the blood. This same belt moves the cassette towards sampling means and then discharging means. This agitation by oscillation may be applied to a single tube as taught in U.S. Pat. No. 4,518,264.

In vortex-type agitation, the cassettes travel along a rail which allows them to be moved from loading means to agitating means and then to sampling means and finally discharging means. As it travels into the agitating means the tube is rotated upon itself, thereby resuspending the cells.

Agitation by inversion can be carried out by a variety of known methods.

In a first method, the tube is taken vertically from the cassette then inverted several times before being placed in sampling means and returned to its place in the cassette. Another method, which is the subject of U.S. Pat. No. 5,665,309, consists of inverting a set of two cassettes. The tube is extracted laterally from the cassette by a gripper which takes the tube to the sampling means. The tube is then returned to the cassette. Another solution, described in U.S. patent application Ser. No. 09/909,996, consists of gripping the tube laterally by the use of tongs. The tube is then agitated by inverting it and returned to the cassette using the same tongs. Sampling is carried out in the cassette.

Other inversion-type agitating means, described in U.S. Pat. No. 5,110,743, use a disc which is able to collect the tubes and which is made up of two subassemblies which can rotate independently of one another. U.S. Pat. No. 4,120,662 describes agitating means comprising two endless screw-type rods held parallel and between which the tubes are agitated in a rotary and translatory movement. From U.S. Pat. No. 3,764,812, agitating means are also known which operate by inverting the tube on itself. The tubes roll over themselves as a result of an alignment of rollers. These agitating means are difficult to integrate into an automatic line.

Consequently, with the exception of the wheel-type means, which are obsolete, it appears that the most up-to-date solution for use in a whole blood apparatus comprises grouping the tubes in a cassette which is then placed in the analyser.

In order to increase the yield and efficacy of the analyses, it is normal to add automatic conveyor belts to the analysers for carrying the tubes which are to be analysed from a storage zone to the point of analysis where they are taken over by the analyser.

Of the automatic conveyor belts, a distinction is drawn between “cassette” type automatic conveyor belts, i.e. those operating with a series of tubes grouped together in a cassette, and “unitary” type automatic conveyor belts, i.e. wherein each tube is placed on its own support.

The belts operating in “cassette” mode are generally fitted to whole blood analysers and enable the cassettes to travel past the various instruments which make up an analytical line. Certain cassettes are intended for whole blood analyses while others are reserved to analyses of plasma or serum.

However, the use of cassette is still limited, particularly when the automatic conveyor has to supply a number of analysers, as all the analysers that make up the automatic line have to be able to accept a single format of cassette.

Another limitation arises from the fact that the tubes are processed in batches, which implies that any other complementary operation needed on a particular tube, such as, for example, a back-up analysis or a different analysis to confirm a diagnosis, involves at least moving the entire cassette to the analysing means. This may constitute a major waste of time spent on handling if complementary and different treatments are needed for each tube in a cassette.

U.S. Pat. No. 5,232,081 describes a line and analysing apparatus operating in cassette mode. U.S. Pat. No. 5,735,387 relates to the conveying of cassettes containing samples which are transported on a conveyor belt to supply analysing apparatus. The solution described does not allow, at any time, independent mixing of a sample contained within the cassette, or even the cassette as a whole.

The lines operating in “unit” mode are fitted principally to analysers working on blood plasma or serum for which there is no need to use agitating means for the tubes before analysis. In this category the tubes are treated as a number of different entities which have their own particular needs in terms of analysis, checking or additional examination.

This operating mode is practical in as much as each tube belongs to a different patient with their own problems. In particular it offers the possibility of carrying out “conditioned analysis” or “reflex testing” (the English term) with ease, which consists in automatically carrying out complementary examination if this can logically assist the diagnosis. This is a source of effectiveness in arriving at a diagnosis and reducing costs by doing away with any additional examinations which are irrelevant to the diagnosis.

Furthermore, there are numerous patents which describe so called“mono-tube” lines. Such a one is U.S. Pat. No. 5,996,309 which describes an automated line which makes it possible to integrate a set of analysers and a set of pre-analytical tools, including conveying and storage systems, control systems and interfaces for directing the tubes. Neither this patent nor application Ser. No. WO 95/03548 makes any reference to the need for mixing and agitation.

It is apparent from the prior art as described by U.S. Pat. No. 5,623,415 that the use of analysing equipment comprising mono-tube rails does not allow the samples to be taken out easily but only conveyed. It will be seen that stirring does not occur in any case. In U.S. Pat. Nos. 4,039,288 and 5,623,415 there are no means for agitating the tubes.

application Ser. No. WO 95/03548, mentioned above, describes an automated line comprising modules for conveying, storing and handling sample tubes. The document emphasises the automation of the operations and the modular nature of the system but does not describe any module for mixing or agitating the samples.

U.S. Pat. No. 5,623,415 describes an automated line which operates in mono-tube mode and comprises a set of systems and instruments for analysing biological liquids. There is no mention anywhere of the integration of a tube agitator nor of the implementation of standardised agitation for tubes of whole blood.

application Ser. No. WO 98/01760 describes a robot and systems for combining several systems and manipulating them. It refers to an automated line comprising a set of pre-analytical tools, including manipulating arms and conveyors, but there is no mention anywhere of the integration of an agitator. Finally, U.S. Pat. No. 6,019,945 describes a conveying device comprising a conveying line which enables the samples to be moved in mono-tube mode by means of an arm.

In order to automate the analysis process entirely it is known to attach, to the analyser, an automatic line for loading the tubes one by one into free locations in cassettes and mechanical means for transferring the loaded cassettes into the loading container of the analyser.

This process requires the following operations to be carried out:
taking hold of a tube by mechanical means in order to transfer it from the support of a unitary line to load it into a free location in the cassette;
repeating this operation to fill up the cassette;
taking hold of the cassette by mechanical means to transfer it from the zone for loading and unloading the tubes from the cassette, which is close to the conveyor, towards the loading container of the analyser;
running the analytical cycle including agitation of the blood, analysis and transfer of the analysed cassette into the unloading container of the analyser;
taking hold of the cassette by mechanical means to transfer it from the unloading container of the analyser to the zone for loading and unloading the tubes of the cassette which is located close to the conveyor;
taking hold of a tube by mechanical means in order to transfer it from its location in this cassette to a free location in the unitary line.

In this process the transition from the unitary mode to the cassette mode, and vice versa at the end of the analysis, loses all the flexibility of the line in unitary mode which is ordinarily attached to analysers of blood plasma or serum.

One aim of the invention is to restore this flexibility of use of the unitary line, irrespective of the type of analyser connected to it.

Advantageously, the device comprises:
agitating means located upstream of at least one analyser;
first transporting means for conveying the tubes of blood one after another past the agitation means;
second transporting means for conveying the tubes of blood which have been mixed by the agitation means, one after the other, to a sampling point of the analyser;
handling means for separately taking hold of the tubes of blood which have not yet been mixed and which are located in front of the agitating means and placing them in the agitating means in order to agitate them using the agitating means, and for separately removing the mixed tubes of blood from the agitating means and placing them in the second transporting means for the mixed tubes to the sampling point of the analyser,
thus making it possible to use at least one analyser which has no agitating means.

The invention thus allows any whole blood analyser installed in an automatic unitary mode line to be connected as simply as an analyser operating with blood serum or plasma.

The very essence of the invention is therefore to transfer the function of agitating the blood, which is normally carried out by the analyser, to agitating means which are external to the analyser, the function of which is to deliver a pre-mixed tube to the analyser.

As a result the analyser has the characteristics of an analytical terminal, the function of which is restricted to carrying out the analysis itself, like an analyser operating with plasma or whole blood. Its basic method of operation is again the unitary mode.

In the invention the agitating means are provided for receiving one or more tubes of whole blood in order to mix them and distribute them to the analyser, when the analyser is ready, but provided that the agitation has been carried out beforehand in accordance with the rules of the art. This therefore presupposes that communication means are provided between the agitating means and the analyser.

In a first embodiment the first transporting means for conveying the tubes of blood to the agitating means and the second transporting means for conveying the mixed tubes to the sampling point of the analyser consist of one and the same conveyor.

In a second embodiment the first transporting means for conveying the tubes of blood to the agitating means and the second transporting means for conveying the mixed tubes to the sampling point of the analyser consist of different conveyors.

In one variant of this second embodiment the first transporting means comprise a main conveyor for conveying the tubes which have not yet been mixed to the agitating means, whereas the second transporting means comprise secondary conveyors for conveying the tubes mixed by the agitating means to the sampling point of the analysers and the agitating means are located respectively on a secondary conveyor upstream of the sampling point of an analyser.

In a third embodiment the agitating means are located respectively on a secondary conveyor upstream of the sampling point of an analyser.

In order to enable the tubes to be conveyed on the second transporting means, for example on a secondary conveyor, the tubes advantageously have identifying means, and reading means are provided for reading the identifying means on the tubes, in order to direct each tube towards an analyser depending on the type of analysis specified by the identifying means.

According to another first embodiment the agitating means for the tubes comprise a number of wheels aligned on the same rotation axis within a housing and the wheels are provided with indentations for receiving the tubes which are to be agitated.

The tubes are introduced into the agitating means by a manipulating arm provided with gripping tongs for gripping the tubes on the first transporting means in order to engage them in free indentations in the wheels of the agitating means and to grip the tubes in order to remove them from the indentations and place them on the second transporting means.

In a second variant the gripping tongs of the manipulating arm are replaced by an electromagnetic module which enables the tube support to be adhered to the end of the manipulating arm each time it is necessary to manipulate a tube.

According to a second embodiment the agitating means comprise a manipulating arm provided with gripping tongs for gripping the tubes on the transporting means and agitating them by rotating the tongs about the longitudinal axis of the manipulating arm.

In a third embodiment the agitating means comprise a cylinder or barrel which enables a free indentation to be positioned vertically with respect to a tube which is to be agitated placed on the first and/or second transporting means.

In another embodiment the first transporting means, the second transporting means and the agitating means are one and the same, e.g. a manipulating arm.

In another aspect the invention relates to an analysing line comprising a supply device as described hereinbefore.

In the description that follows which is provided solely by way of example, reference is made to the accompanying drawings, wherein:

FIG. 1 is a basic diagram illustrating the positioning according to the invention of an agitator on the conveyor of a unitary line for conveying tubes which enables tubes of blood ready to be analysed to be distributed to a whole blood analyser;

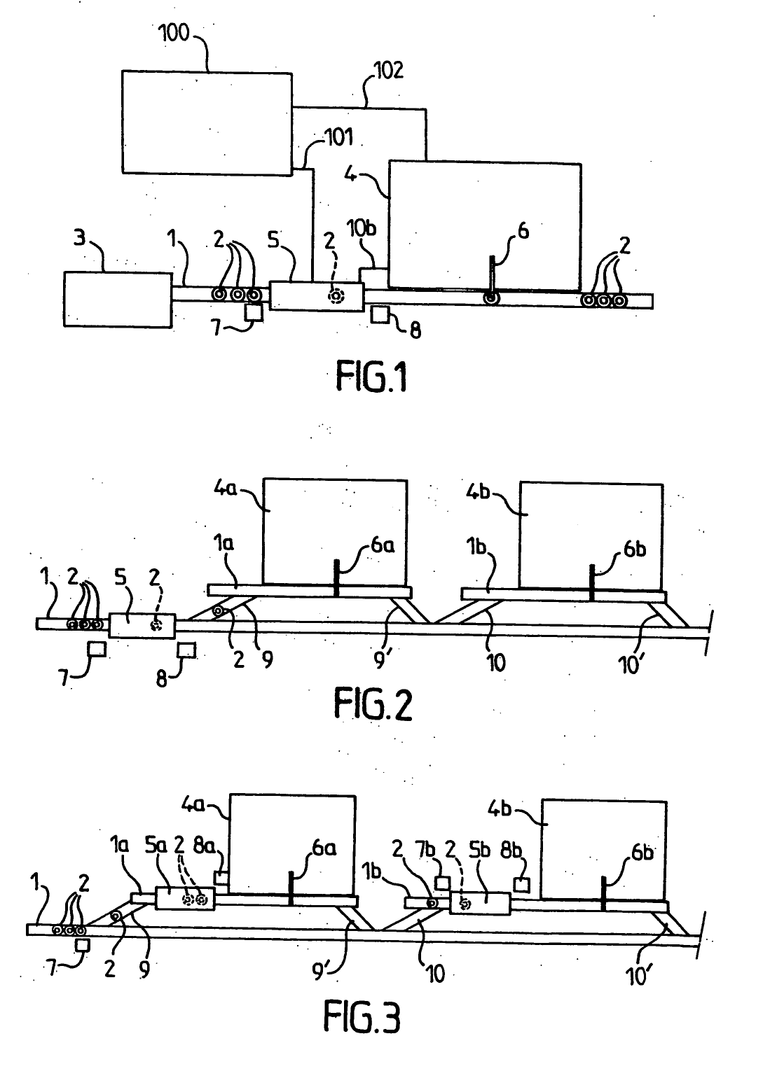

FIG. 2 is a basic diagram to illustrate the positioning of an agitator on the conveyor of an automatic conveying line according to the invention which will supply two different analysers;

FIG. 3 is a basic diagram to illustrate an example of the conveying of tubes on an automatic conveyor line which will supply two agitators associated with two different analysers;

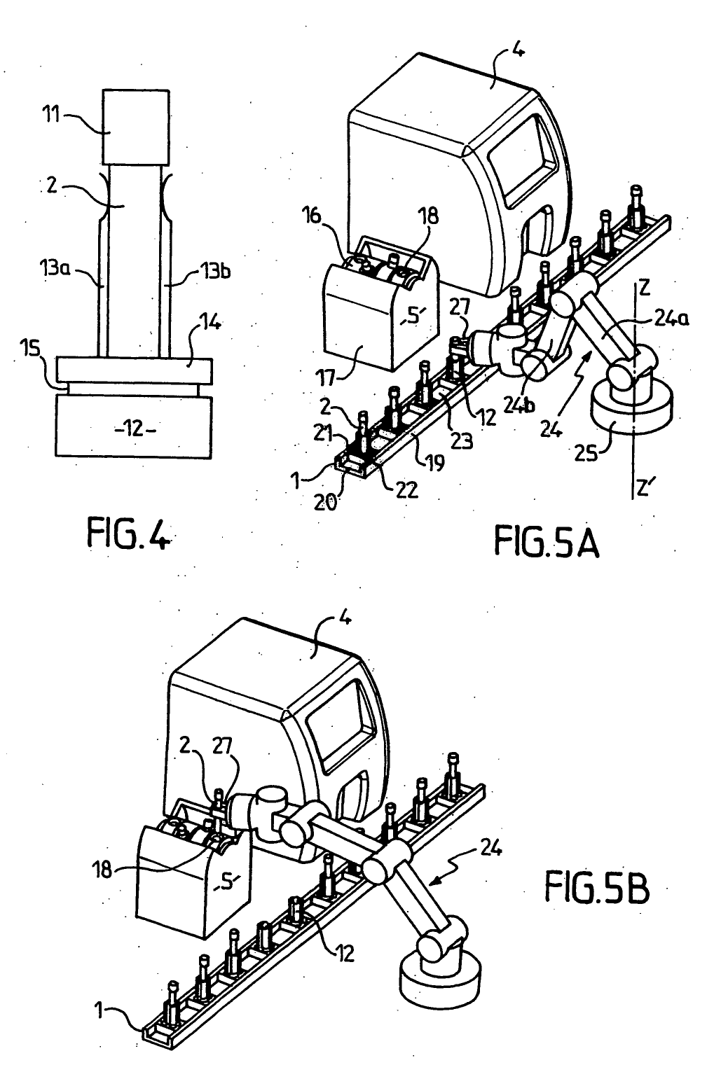

FIG. 4 is a view showing an embodiment of a tube support member of a conveying line according to the invention;

FIGS. 5A to 9B respectively show first, second, third, fourth and fifth embodiments of a conveying and agitating device for tubes according to the invention which operates according to the basic diagram in FIG. 1; and

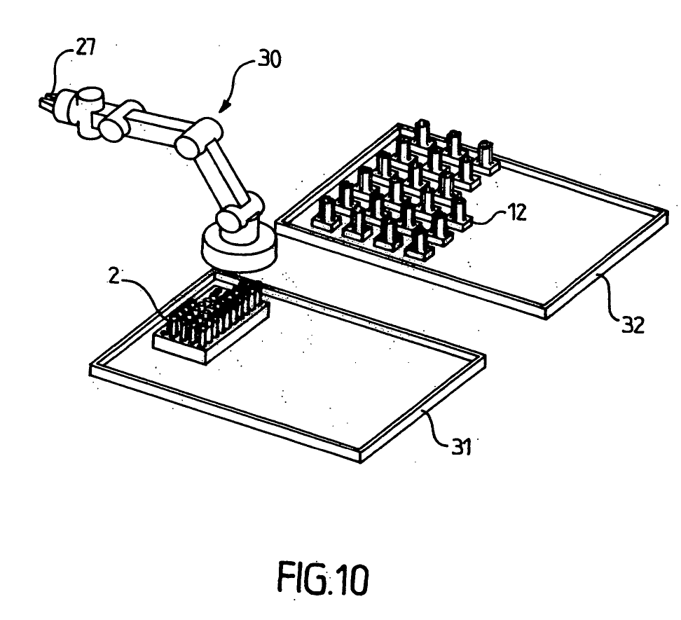

FIG. 10 is a perspective view illustrating a sixth embodiment of a tube conveying and agitating device according to the invention, in which the first transporting means, the second transporting means and the agitating means are one and the same means, consisting in this specific embodiment of a manipulating arm.

In FIG. 1 the automatic conveying line for tubes comprises on the one hand a conveyor 1 in the form of a rail for transporting the tubes of blood 2 awaiting analysis from a storage zone 3 to an analyser 4 and on the other hand a tube agitator 5 arranged on the line 1 between the storage zone 3 and the analyser 4.

The tubes 2 awaiting analysis are aligned one after the other on the conveyor 1 and travel from the storage zone 3 to the agitator 5 which is charged with mixing the blood cells contained in each tube. The tubes 2 leave the agitator 5 and are guided by the conveyor 1 towards a sampling device 6 of the analyser 4. Each tube 2 is identified by a reader 7 before entering the agitator 5 and on leaving it by a reader 8.

The readers 7 and 8 read the information associated with the labelled tube, for example in the form of a bar code placed on a label stuck to the tube, and transmits this information to a processing component of the analyser 4 or to a central data processing and control unit 100, which is diagrammatically shown in FIG. 1. This information informs the analyser in particular as to the type of analysis and the type of action which has to be carried out on the contents of each tube. The information may be supplied directly by the tube or by a component associated with the tube, in particular by a support carrying the tube.

FIG. 1 shows the interconnection between the agitator 5, the analyser 4 and the central unit 100. The agitator 5 may be controlled and exchange data with the central unit 100 or with the analyser or analysers 4 present in the line.

The connection between the agitator 5, the analysers 4 and the central unit 100, makes it possible to control the agitation phases and to time the transportation of the tubes along the line in optimum manner.

As can be seen from FIG. 1, the central unit 100 (or data processing system) of the line is connected to the agitator 5 by a network connection 101 which allows data to be exchanged between the agitator 5 and the central processor. This data may be information as to the samples present in the agitator or information concerning the cycle currently taking place in the agitator.

The agitator 5 is connected to the analyser 4 through a network connection 102 which enables information relating to the samples being agitated to be transferred to the analyser and also information relating to the cycles taking place in the agitator. The aim here is to optimise the operating cycles of the analyser 4 and agitator 5. The information between the agitator 5 and the analyser 4 may also be transferred via the central processor.

The principle of conveying described above with reference to FIG. 1 may be extended to the conveying and agitating of tubes from a single storage zone to different analysers. Embodiments of its use are described hereinafter with reference to FIGS. 2 and 3, wherein elements corresponding to those in FIG. 1 have been given the same reference numerals.

In FIG. 2, the main conveyor 1 is connected to two secondary conveyors 1a and 1b which supply two different analysers 4a and 4b with tubes. The two secondary conveyors 1a, 1b are interposed respectively between the two analysers 4a, 4b and an agitator 5 connected to the main conveyor 1. The tubes awaiting analysis travel one after the other along the main conveyor 1 and are agitated one by one in the agitator 5, from which they emerge one by one after agitation by the agitator 5, to be directed through switch points 9 and 10 to sampling means 6a, 6b of the analysers 4a and 4b.

As in FIG. 1, two readers 7 and 8 are arranged at the entrance and exit of the agitator 5 for reading from the labels the information relating to each tube and transmitting it to the processing component of the analysers 4a and 4b or to a checking station, not shown, which directs each tube towards one of the two analysers depending in particular on the nature of the analysis to be carried out, which is recorded on the label. The tubes then return to the conveyor 1 through exit pathways or switch points 9′ and 10′.

In FIG. 3 the main conveyor also supplies two different analysers 4a, 4b by means of two secondary conveyors 1a, 1b connected respectively to the main conveyor 1 through two switch points 9 and 10. Differently from the embodiment shown in FIG. 2, the device comprises two agitators 5a and 5b which are interposed respectively on the two secondary conveyors 1a and 1b between the two analysers 4a and 4b and the switch points 9 and 10 connecting them to the main conveyor 1. The tubes 2 are directed towards the secondary conveyor 1a by the switch point 9 or towards the secondary conveyor 1b by the switch point 10 depending on the type of analysis to be carried out, which has been read off from the label on each tube by the reader 7 placed on the main conveyor 1 in advance of the points steering the tubes towards the analysers 4a and 4b. The tubes can then return to the conveyor 1 in the same way as in FIG. 2.

The tubes 2 to be analysed by the analyser 1a are agitated by the agitator 5a from which they emerge to be directed on the secondary conveyor 1a towards the sampling means 6a of the analyser 1a. The tubes 2 to be analysed by the analyser 1b are agitated by the agitator 5b and emerge from the agitator 5b to be directed on the secondary conveyor 1b towards the sampling means 6b of the analyser 4b. Readers 8a and 8b are placed at the exit from the agitators 5a, 5b to allow the analysers 4a and 4b to identify each of the tubes leaving the agitators 5a and 5b.

In the foregoing examples the capacities of the agitators in numbers of tubes are determined by taking account of the analysing rates of the analysers which are being supplied and allowing for the minimum agitation time for the tubes which is necessary for satisfactory resuspension of the blood cells which are to be analysed in each tube.

As shown in FIG. 4, the tubes 2 together with their stoppers 11 are guided respectively on the conveyor 1 and on the secondary conveyors 1a, 1b by support members 12 on which they are held vertically between two spring plates 13a and 13b. The spring plates 13a, 13b are fixed at one end to a base 14 of each of the support members 12. A groove 15 may optionally be provided in the base 14 to allow the support member 12 to be guided on the main conveyor 1 and on the secondary conveyors 1a and 1b. The driving of the support members 12 on the main conveyor and on the secondary conveyors 1a, 1b may be carried out by any known method (not shown).

As is evident from the embodiments shown in FIGS. 5A to 9B the agitator 5 may take various forms.

According to a first embodiment shown in FIGS. 5A and 5B in which the elements corresponding to those in FIGS. 1 to 4 bear the same reference numerals, the agitation of the tubes is carried out by an agitator 5 comprising a plurality of wheels 16 aligned on the same rotation axis inside a housing 17. The wheels 16 are provided with indentations 18 to accommodate the tubes 2 which are to be agitated. The conveying device is in the form of a belt 19, particularly a smooth belt, having a base 20 bounded by two edges 21, 22.

Each tube 2 is fitted inside a support member 12 placed within the belt 19, leaving a free space 23 between two successive support members. The tubes 2 are introduced into the agitator 5 by a manipulating arm 24 resting on a base 25. The manipulating arms 24 comprises two half arms 24a and 24b jointed to one another at one end in a plane which is rotatable about an axis ZZ′ perpendicular to the plane formed by the base 20 of the conveyor belt 19. The manipulating arm 24 makes it possible to grip the tubes 2 on the conveyor 1, with the aid of gripping tongs 27 jointed to a free end of a half arm 24b, on the one hand, in order to engage them in the free indentations 18 in the wheels 16 of the agitator 5 and, on the other hand, to grip the tubes 2 in order to remove them from the indentations 18 and place them on the conveyor 1.

The apparatus operates as follows. After a request from the whole blood analyser 4 or from the control station (central unit 100) of the automated line, the manipulating arm 24 positions itself in front of a tube 2 placed on a location 23 of conveyor 1, and the gripper tongs 27 of the manipulating arm 24 seize the tube. At the same time the agitator 5 looks for a free location and positions itself in the “awaiting tube” mode.

When an indentation 18 of the agitator 5 is free and is positioned in order to receive a new tube 2, the manipulating arm 24 takes the tube 2 out of its support 12 to fit it into the indentation 18, as shown in FIG. 5B, and allow the agitator 5 to agitate the tube. When the agitation of the tube 2 has ended the manipulating arm 24 takes the tube 2 again and puts it back in its support 12 on the conveyor 1. The conveyor 1 then transports the agitated tube 2 to the analyser 4 which can thus proceed to analyse its contents.

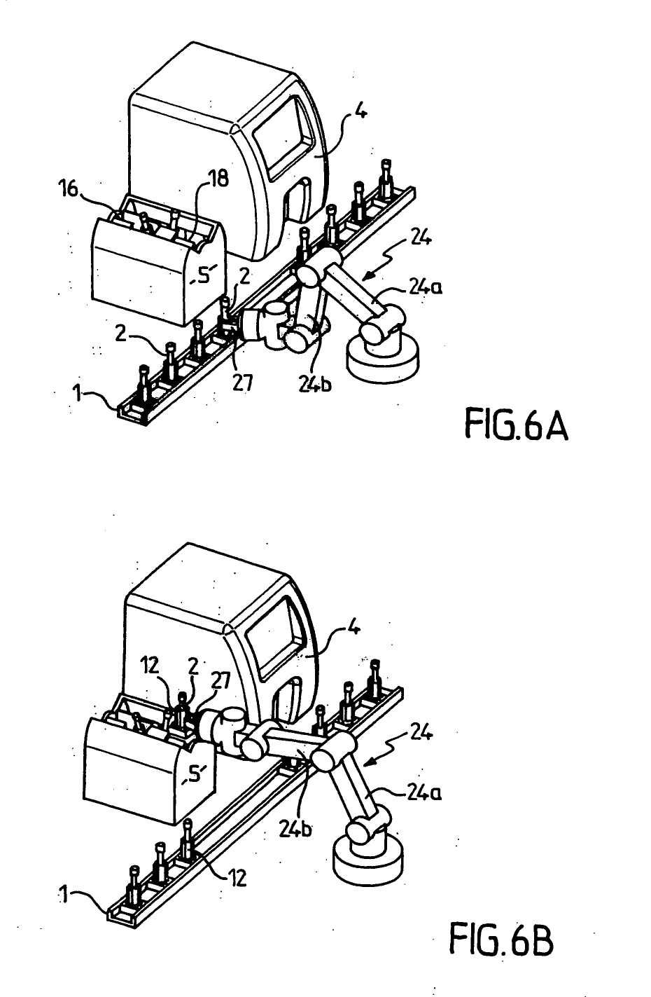

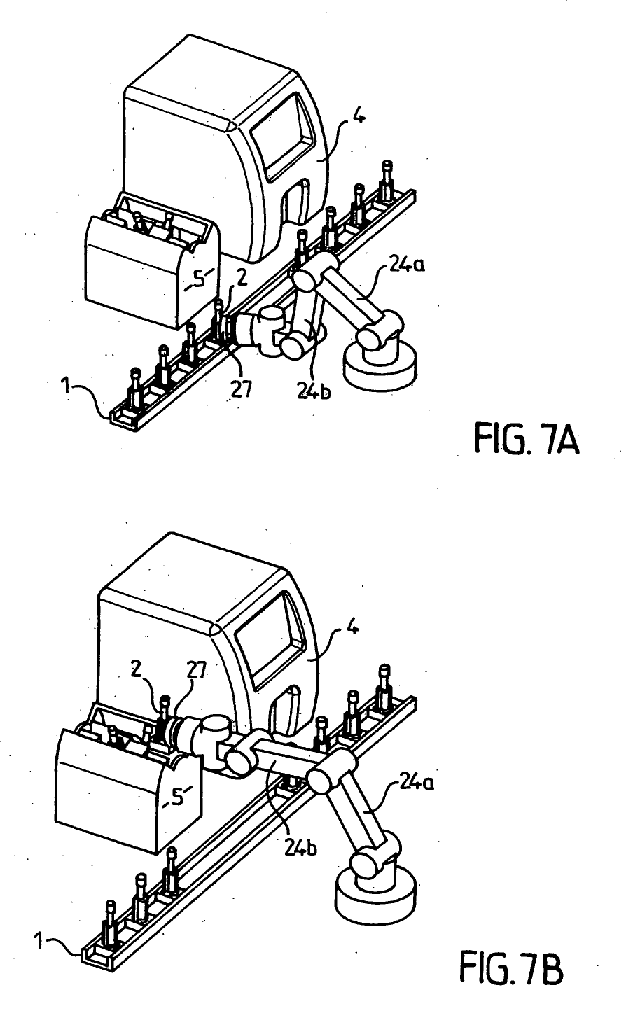

The second embodiment shown in FIGS. 6A and 6B differs from the one of FIGS. 5A and 5B in that each indentation in the wheels 16 of the agitator 5 is designed to receive a tube 2 mounted on a support 12. The manipulating arm 24 is thus actuated to take hold of a tube 2 and its support 12 both to carry them into a free indentation 18 in the wheels 16 of the agitator 5 and to remove them from the agitator 5 and, after agitation, place them back on the conveyor 1. As in FIGS. 5A and 5B the manipulating arm 24 comprises at its end opposite the end connected to the base a gripper 27 for gripping the tube 2, but it would also advantageously be possible, according to another alternative embodiment shown in FIGS. 7A and 7B, to replace the gripper 27 by an electromagnetic module 27 controlled by the analyser 4 or the control station, for adhering the tube support 12 to the end of the manipulating arm 24 each time that it is necessary to manipulate a tube 2.

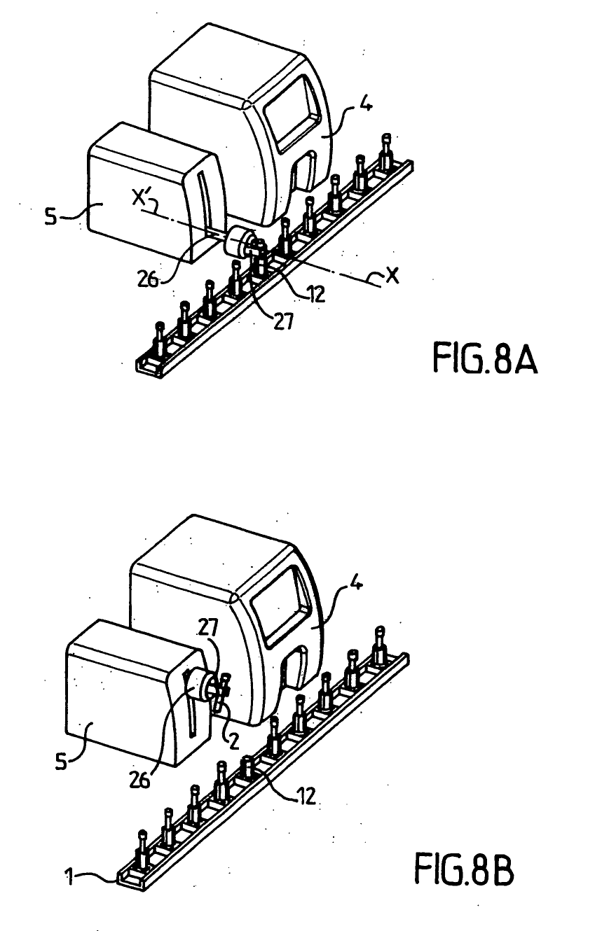

In the third embodiment shown in FIGS. 8A and 8B in which elements corresponding to those in FIGS. 5A to 7B have been given the same reference numerals, a manipulating arm 26 is carried by the agitator 5 and is made to rotate about its longitudinal axis XX′ under the control of the analyser 4 or the control station in order to allow agitation of the tube 2 gripped by the gripper 27 placed at its end. In contrast to embodiments described previously, the arm 26 of the agitator S is positioned in front of a tube 2 which has to be agitated under the control of the whole blood analyser 4 or the control station. Using the gripper 27 the agitator 5 takes up the tube which is to be analysed 2, removing it from its support 12. In this movement the arm 26 moves upwards to position itself in the agitation mode, c.f. FIG. 8B, but it is controlled so as to agitate the tube 2 with a rotary movement. When the agitation of the tube 2 has ended the arm 26 moves down again and returns the tube 2 to its support 12.

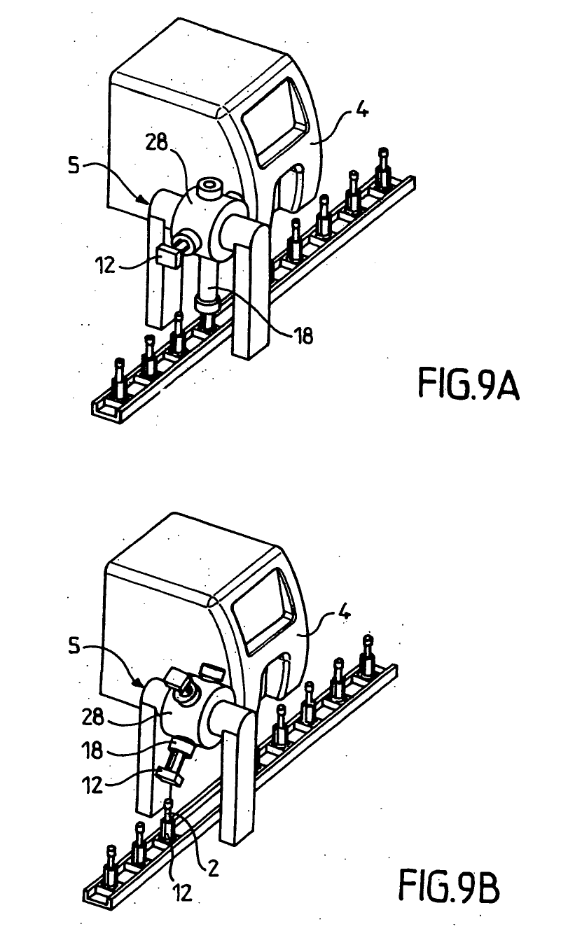

In the fourth embodiment shown in FIGS. 9A and 9B in which elements corresponding to the embodiment in FIGS. 8A and 8B have been given the same reference numerals, the agitator 5 comprises a cylinder or barrel 28 which allows a free indentation 18 to be positioned vertically with respect to a tube 2 which is to be agitated, placed on the conveyor 1. A downward vertical movement of the indentation 18 allows the tube 2 and its support 12 to be picked up. Then the indentation 18 moves upwards and positions itself in the barrel 28 which undertakes a series of rotations in order to agitate the tube 2. At the end of the agitation the barrel 28 positions itself so as to be able to set the tube 2 and its support 12 down on the conveyor 1.

In the embodiment shown in FIG. 10, the first transporting means, the second transporting means and the agitating means are made in the form of one and the same component which in this instance is a manipulating arm 30. This arm is provided with a gripper 27 at its free end and may be analogous to the arm 24 or 26 described hereinbefore. The arm can move an as yet unmixed tube 2 contained in a storage zone 31 to carry it towards the agitating means (not shown). Then, after agitation, the arm carries the tube 2 in order to place it in an individual support 12 in another storage zone 32, for the purpose of analysis. Of course, the arm 30 could be replaced by any other component capable of moving a tube in a three-dimensional space, e.g. a displacement means moving in three perpendicular directions.

1-17. (canceled)

18. A device for supplying whole blood analyzers with tubes of blood, comprising:
agitating means located upstream of at least one analyzer;
first transporting means for transporting the tubes of blood one after the other to the agitating means;
second transporting means for transporting the tubes of blood mixed by the agitating means, one after another, to a sampling point, of the analyzer; and
manipulating means for separately picking up the tubes of blood which have not yet been mixed, located in front of the agitating means, and placing them in the agitating means to agitate them using the agitating means, and for separately removing the tubes of blood from the agitating means and placing them in the second transporting means for the mixed tubes to the sampling point of the analyzer, which makes it possible to use at least one analyzer that has no agitating means.

19. A device according to claim 18, wherein the first transporting means for transporting the tubes of blood to the agitating means and the second transporting means for transporting the mixed tubes to the sampling point of the analyzer include one and the same conveyor.

20. A device according to claim 18, wherein the first transporting means for transporting the tubes of blood to the agitating means and the second transporting means for transmitting the mixed tubes to the sampling point of the analyzer include different conveyors.

21. A device according to claim 20, wherein the first transporting means comprises a main conveyor for transporting the not yet mixed tubes to the agitating means, whereas the second transporting means comprises secondary conveyors for transporting the tubes mixed by the agitating means to the sampling point of the analyzer.

22. A device according to claim 21, wherein the agitating means are located respectively on a secondary conveyor upstream of the sampling point of the analyzer.

23. A device according to claim 18, wherein the tubes have identifying means, and further comprising reading means for reading the identifying means of the tubes, thus enabling each tube to be directed towards an analyzer depending on the type of analysis specified by the identifying means.

24. A device according to claim 18, wherein the agitating means comprises a manipulating arm provided with a gripper for taking hold of the tubes on the first transporting means and agitating the tubes by rotating the gripper about the longitudinal axis of the manipulating arm.

25. A device according to claim 18, wherein the agitating means comprises a cylinder or barrel that enables a free indentation to be positioned vertically with respect to a tube which is to be agitated, placed on the first transporting means.

26. A device according to claim 18, wherein the agitating means comprises a plurality of wheels aligned along a same rotation axis inside a housing, and the wheels are provided with indentations for accommodating tubes that are to be agitated.

27. A device according to claim 18, wherein the first and/or second transporting means take the form of a conveyor belt.

28. A device according to claim 27, wherein each tube fits inside a support member located inside the first and/or second transporting means.

29. A device according to claim 26, further comprising a manipulating arm for introducing the tubes, one by one, into the agitating means.

30. A device according to claim 29, wherein the manipulating arm comprises a gripper for gripping the tubes on the first transporting means to fit the tubes into the free indentations in the wheels of the agitating means and to grip the tubes to remove the tubes from the indentations and place the tubes on the second transporting means.

31. A device according to claim 26, wherein each indentation in the wheels of the agitating means is configured to accommodate a tube mounted on a support.

32. A device according to claim 29, wherein the manipulating arm comprises an electromagnetic module for adhering the tube support to the end of the manipulating arm each time it is necessary to manipulate a tube.

33. A device according to claim 18, wherein the first transporting means, the second transporting means, and the agitating means are a same component.

34. Analysis line comprising a supply device according to claim 33.
